(19) United States
(12) Patent Application Publication
(10) Pub. No.: US 2020/0003942 A1
(43) Pub. Date: Jan. 2, 2020

(54) ORGANIC ELECTROLUMINESCENT DISPLAY DEVICE, PHASE DIFFERENCE FILM, AND CIRCULARLY POLARIZING PLATE

(71) Applicant: FUJIFILM Corporation, Tokyo (JP)

(72) Inventor: Kunihiro ATSUMI, Kanagawa (JP)

(73) Assignee: FUJIFILM Corporation, Tokyo (JP)

(21) Appl. No.: 16/561,452

(22) Filed: Sep. 5, 2019

Related U.S. Application Data
(63) Continuation of application No. PCT/JP2018/008303, filed on Mar. 5, 2018.

(30) Foreign Application Priority Data
Mar. 8, 2017 (JP) 2017-044102

(51) Int. Cl. G02B 5/30

(52) U.S. Cl. CPC G02B 5/3016; H05B 33/02

(57) ABSTRACT

The present invention provides: an organic electroluminescent display device that further suppresses reflection of external light when viewed in an oblique direction; a phase difference film; and a circularly polarizing plate. This display device has an organic electroluminescent display panel, and a circularly polarizing plate arranged on the display panel, in which the circularly polarizing plate has a polarizer and a phase difference film, the phase difference film has, from a side of the polarizer, a negative A-plate, and a positive A-plate, the in-plane retardation of the negative A-plate at a wavelength of 550 nm is more than 50 nm and less than 90 nm, and the in-plane retardation of the positive A-plate at a wavelength of 550 nm is 100 to 200 nm, and the angle formed by the in-plane slow axis of the negative A-plate and the in-plane slow axis of the positive A-plate is 45°±10°.

### CROSS-REFERENCE TO RELATED APPLICATIONS

This application is a Continuation of PCT International Application No. PCT/JP2018/008303 filed on Mar. 5, 2018, which claims priority under 35 U.S.C. § 119(a) to Japanese Patent Application No. 2017-044102 filed on Mar. 8, 2017. The above application is hereby expressly incorporated by reference, in its entirety, into the present application.

### BACKGROUND OF THE INVENTION

### 1. Field of the Invention

The present invention relates to an organic electroluminescent display device, a phase difference film, and a circularly polarizing plate.

### 2. Description of the Related Art

Conventionally, in order to suppress adverse effects of reflection of external light, a circularly polarizing plate has been used in an organic electroluminescent (EL) display device. As a circularly polarizing plate, for example, as described in WO2016/158298A, an aspect in which an optically anisotropic layer A, an optically anisotropic layer B, and a polarizer are combined is disclosed.

### SUMMARY OF THE INVENTION

On the other hand, in recent years, in a display device typified by an organic EL display device, further improvement in viewing angle characteristics has been required. More specifically, in a display device including a circularly polarizing plate, it is required to further reduce reflection of external light in the case of being viewed in an oblique direction.

The present inventors have examined the external light reflection characteristics of the organic EL display device including the circularly polarizing plate described WO2016/158298A and found that the suppression of the reflection of external light in the case of being viewed in an oblique direction does not reach the recently required level and further improvement is required.

The present invention is made in consideration of the above circumstances and an object thereof is to provide an organic electroluminescent display device that further suppresses reflection of external light in a case of being viewed in an oblique direction.

Another object of the present invention is to provide a phase difference film and a circularly polarizing plate that in the case where the phase difference film and the circularly polarizing plate are applied to a display device, further suppress reflection of external light in a case of being viewed in an oblique direction.

As a result of intensive investigations on problems in the related art, the present inventors have found that in a case of being viewed in an oblique direction, a change in the relationship between the retardation of a λ/4 plate or an in-plane slow axis of the λ/4 plate and the absorption axis of a polarizer is the cause of the deterioration of the oblique direction reflectivity, and thus the above problems can be solved by compensating for changes in retardation and axial angle by using a negative A-plate showing a predetermined in-plane retardation between a positive A-plate as a λ4 plate and a polarizer.

That is, the present inventors have found that the above objects can be achieved by adopting the following configurations.

(1) An organic electroluminescent display device comprising: an organic electroluminescent display panel; and a circularly polarizing plate arranged on the organic electroluminescent display panel,

in which the circularly polarizing plate has a polarizer, and a phase difference film,

the phase difference film has, from a polarizer side, a negative A-plate, and a positive A-plate,

an in-plane retardation of the negative A-plate at a wavelength of 550 nm is more than 50 nm and 90 nm or less,

an in-plane retardation of the positive A-plate at a wavelength of 550 nm is 100 to 200 nm,

an angle formed between an in-plane slow axis of the negative A-plate and an in-plane slow axis of the positive A-plate is 45°±10°, and

the in-plane slow axis of the negative A-plate and an absorption axis of the polarizer are parallel to each other.

(2) The organic electroluminescent display device according to (1), in which the in-plane retardation of the negative A-plate at a wavelength of 550 nm is more than 50 nm and less than 80 nm.

(3) The organic electroluminescent display device according to (1) or (2), in which the positive A-plate exhibits reverse wavelength dispersibility.

(4) The organic electroluminescent display device according to any one of (1) to (3), in which the in-plane retardation of the positive A-plate at a wavelength of 550 nm is 117 to 157 nm.

(5) The organic electroluminescent display device according to any one of (1) to (4), in which the negative A-plate and the positive A-plate have a thickness of 10 μm or less, respectively.

(6) The organic electroluminescent display device according to any one of (1) to (5), in which both the negative A-plate and the positive A-plate are layers formed by using a liquid crystal compound.

(7) A phase difference film comprising: a negative A-plate; and a positive A-plate,

in which an in-plane retardation of the negative A-plate at a wavelength of 550 nm is more than 50 nm and 90 nm or less,

an in-plane retardation of the positive A-plate at a wavelength of 550 nm is 100 to 200 nm, and

an angle formed between an in-plane slow axis of the negative A-plate and an in-plane slow axis of the positive A-plate is 45°±10°.

(8) The phase difference film according to (7), in which the in-plane retardation of the negative A-plate at a wavelength of 550 nm is more than 50 nm and less than 80 nm.

(9) The phase difference film according to (7) or (8), in which the positive A-plate exhibits reverse wavelength dispersibility.

(10) The phase difference film according to any one of (7) to (9), in which the in-plane retardation of the positive A-plate at a wavelength of 550 nm is 117 to 157 nm.

(11) The phase difference film according to any one of (7) to (10), in which the negative A-plate and the positive A-plate have a thickness of 10 μm or less, respectively.

(12) The phase difference film according to any one of (7) to (11), in which both the negative A-plate and the positive A-plate are layers formed by using a liquid crystal compound.

(13) A circularly polarizing plate comprising: a polarizer; and the phase difference film according to any one of (7) to (12) arranged on the polarizer,

in which, from a polarizer side, the negative A-plate and the positive A-plate are arranged in this order, and

an in-plane slow axis of the negative A-plate and an absorption axis of the polarizer are parallel to each other.

According to the present invention, it is possible to provide an organic electroluminescent display device that further suppresses reflection of external light in a case of being viewed in an oblique direction.

According to the present invention, it is also possible to provide a phase difference film and a circularly polarizing plate that in the case where the phase difference film and the circularly polarizing plate are applied to a display device, further suppress reflection of external light in a case of being viewed in an oblique direction.

### BRIEF DESCRIPTION OF THE DRAWINGS

FIG. 1 is a cross-sectional view showing a phase difference film according to the present invention.

FIG. 2 is a view showing a relationship between an in-plane slow axis of a negative A-plate and an in-plane slow axis of a positive A-plate in the phase difference film according to the present invention.

FIG. 3 is a cross-sectional view showing a circularly polarizing plate according to the present invention.

FIG. 4 is a view showing a relationship between an absorption axis of a polarizer, an in-plane slow axis of a negative A-plate, and an in-plane slow axis of a positive A-plate in the circularly polarizing plate according to the present invention.

FIG. 5 is a cross-sectional view showing an organic EL display device according to the present invention.

### DESCRIPTION OF THE PREFERRED EMBODIMENTS

Hereinafter, the present invention will be described in detail. In the present specification, the numerical value range expressed by the term “to” means that the numerical values described before and after “to” are included as a lower limit and an upper limit, respectively. First, the terms used in the present specification will be described.

In the present invention, Re(λ) and Rth(λ) respectively represent an in-plane retardation and a retardation in a thickness direction at a wavelength λ. Unless otherwise specified, the wavelength λ is 550 nm.

In the present invention, Re(λ) and Rth(λ) are values measured at wavelength λ in AxoScan OPMF-1 (manufactured by Opto Science, Inc.). By inputting the average refractive index ((nx+ny+nz)/3) and the film thickness (d (μm)) to AxoScan, the following expressions can be calculated.

Slow axis direction (°)

Re(λ)=R0(λ)

Rth(λ)=((nx+ny)/2−nz)×d

R0(λ) is expressed as a numerical value calculated by AxoScan OPMF-1 but means Re(λ).

In the present specification, the refractive indices nx, ny, and nz are measured using an Abbe refractometer (NAR-4T, manufactured by Atago Co., Ltd.), and a sodium lamp (λ=589 nm) is used as a light source. In addition, in the case where the wavelength dependence is measured, the wavelength dependence can be measured using a combination of a multi-wavelength Abbe refractometer DR-M2 (manufactured by Atago Co., Ltd.) and an interference filter.

In addition, as the refractive index, values described in “Polymer Handbook” (John Wiley&Sons, Inc.) and catalogs of various optical films can also be used. The values of the average refractive index of major optical films are as follows: cellulose acylate (1.48), cycloolefin polymer (1.52), polycarbonate (1.59), polymethyl methacrylate (1.49), and polystyrene (1.59).

In the present specification, the Nz factor is a value obtained from Nz=(nx−nz)/(nx−ny).

In the present specification, the term “visible light” refers to light in a wavelength range of 380 to 800 nm.

In the present specification, an angle (for example, an angle of “90°” or the like) and an angular relationship (for example, “orthogonal”, “parallel”, and “crossing at 45°”) include the margin of allowable error in the technical field to which the present invention belongs. For example, the allowable error means that the margin of the error is within a precise angle ±10°. A difference between an actual angle and the precise angle is preferably 50 or less, more preferably 30 or less, even more preferably 10 or less, and particularly preferably less than 1°.

In the present specification, the definition of A-plate is as follows.

There are two kinds of A-plates: a positive A-plate and a negative A-plate, and when the refractive index in the slow axis direction (the direction in which the refractive index in the plane is maximum) in the film plane is nx, the refractive index orthogonal to the in-plane slow axis in the plane is ny, and the refractive index in the thickness direction is nz, the positive A-plate satisfies the relationship of Expression (A1), and the negative A-plate satisfies the relationship of Expression (A2). The positive A-plate has a positive Rth value and the negative A-plate has a negative Rth value.

nx>ny≅nz Expression (A1)

ny<nx≅nz Expression (A2)

The expression “≅” includes not only a case in which both are completely the same but also a case in which both are substantially the same. Regarding the expression “substantially the same”, for example, “ny≅nz” includes a case in which (ny−nz)×d (wherein d represents a film thickness) is −10 to 10 nm and preferably −5 to 5 nm, and “nx≅nz” includes a case in which (nx−nz)×d is −10 to 10 nm and preferably −5 to 5 nm.

In the present specification, an “absorption axis” of a polarizer means a direction in which absorbance is maximized. A “transmission axis” means a direction in which an angle with respect to the “absorption axis” is 90°.

In the present specification, an “in-plane slow axis” of each of a negative A-plate and a positive A-plate means a direction in which a refractive index in a plane is maximized.

Hereinafter, an organic electroluminescent display device (organic EL display device), a phase difference film, and a circularly polarizing plate according to embodiments of the present invention will be described with drawings.

In the following, the phase difference film, the circularly polarizing plate, and the organic EL display device will be described in this order.

<Phase Difference Film>

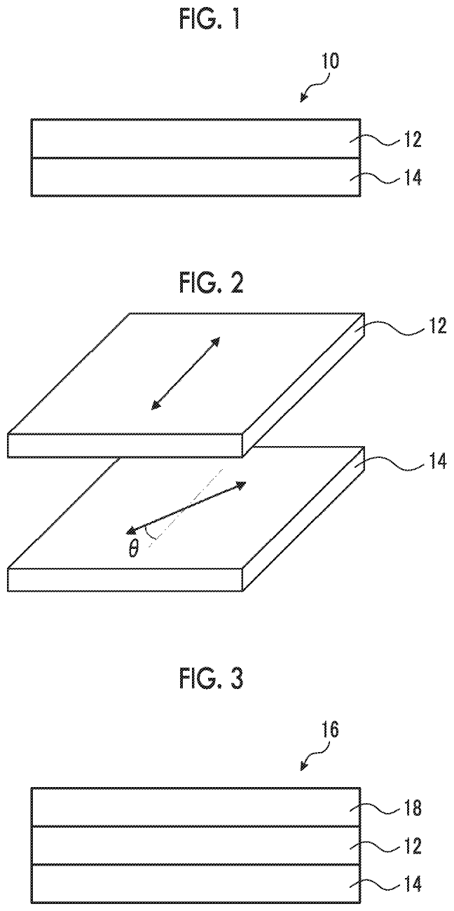

A phase difference film according to an embodiment of the present invention will be described with the drawings. FIG. 1 is a cross-sectional view showing a phase difference film according to an embodiment of the present invention. The drawing in the present invention is a schematic view and the relationship and positional relationship between the thicknesses of the layers are not limited to the embodiment in FIG. 1.

A phase difference film 10 has a negative A-plate 12 and a positive A-plate 14.

In addition, in FIG. 2, the relationship between an in-plane slow axis of the negative A-plate 12 and an in-plane slow axis of the positive A-plate 14 is shown. In FIG. 2, the arrows in the negative A-plate 12 and the positive A-plate 14 indicate the direction of the in-plane slow axis in the respective layers.

Hereinafter, each member included in the phase difference film 10 will be described in detail.

(Negative A-Plate)

The negative A-plate is a layer arranged on a side closest to the polarizer in the circularly polarizing plate described later. The negative A-plate preferably has a single structure.

The in-plane retardation of the negative A-plate at a wavelength of 550 nm is more than 50 nm and 90 nm or less, preferably more than 50 nm and 80 nm or less, and more preferably 65 to 75 nm from the viewpoint of further suppressing reflection of external light in the case where an organic EL display device is viewed in an oblique direction device (hereinafter, simply referred to as “from the viewpoint that the effect of the present invention is more excellent).

The Rth(550) of the negative A-plate, which is a retardation in a thickness direction at a wavelength of 550 nm, is preferably −45 nm or more and less than −25 nm, more preferably −40 nm or more and less than −25 nm, and even more preferably −37.5 to −32.5 nm from the viewpoint that the effect of the present invention is more excellent.

The negative A-plate may exhibit forward wavelength dispersibility (characteristics in which the in-plane retardation decreases as the measurement wavelength increases) or reverse wavelength dispersibility (characteristics in which the in-plane retardation increases as the measurement wavelength increases). The forward wavelength dispersibility and the reverse wavelength dispersibility are preferably exhibited in the visible light range.

In order to set the in-plane retardation of the negative A-plate to appropriately exhibit forward wavelength dispersibility, specifically, the Re(450 nm)/Re(550 nm) of the negative A-plate is preferably more than 1.00 and 1.20 or less and more preferably 1.04 to 1.18, and the Re(650 nm)/Re(550 nm) of the negative A-plate is preferably 0.70 or more and less than 1.00 and more preferably 0.80 to 0.98.

The Re(450) and the Re(650) represent in-plane retardations of the negative A-plate measured at wavelengths of 450 nm and 650 nm, respectively.

The thickness of the negative A-plate is not particularly limited and is adjusted such that the in-plane retardation is in a predetermined range. From the viewpoint of reducing the thickness of the phase difference film, the thickness is preferably 10 μm or less, more preferably 0.5 to 5.0 μm, and even more preferably 0.5 to 2.0 μm.

In the present specification, the thickness of the negative A-plate means the average thickness of the negative A-plate. The average thickness is obtained by measuring the thickness at 5 random points in the negative A-plate and arithmetically averaging those values.

The negative A-plate is preferably a layer formed by using a liquid crystal compound. However, as long as predetermined characteristics such as the above-mentioned in-plane retardation are satisfied, the positive A-plate may be constituted of another material. For example, the positive A-plate may be formed by using a polymer film (particularly, a polymer film subjected to a stretching treatment).

Conventionally, a rigid flat type display panel has been mainly used as an organic electroluminescent display panel (organic EL display panel). However, in recent years, a foldable flexible organic EL display panel has been proposed. For a circularly polarizing plate used for such a flexible organic EL display panel, it is required that the circularly polarizing plate itself is excellent in flexibility. From this viewpoint, since the negative A-plate formed by using a liquid crystal compound is more flexible than a polymer film, the circularly polarizing plate can be suitably applied to a flexible organic EL display panel.

In addition, for the above reason, it is preferable that the positive A-plate described in detail later is a positive A-plate formed by using a liquid crystal compound.

That is, as long as the circularly polarizing plate includes a negative A-plate formed by using a liquid crystal compound, and a positive A-plate formed by using a liquid crystal compound, the circularly polarizing plate can be more suitably applied to a flexible organic EL display panel.

The kind of liquid crystal compound is not particularly limited but, liquid crystal compounds can be classified into a rod-like type (rod-like liquid crystal compound) and a disk-like type (disk-like liquid crystal compound, discotic liquid crystal compound) based on the shape thereof. Further, each type of liquid crystal compound includes a low molecular type and a high molecular type. A high molecule generally indicates a molecule having a polymerization degree of 100 or more (Masao Doi; Polymer Physics-Phase Transition Dynamics, 1992, IWANAMI SHOTEN, PUBLISHERS, page 2). A mixture of two or more kinds of rod-like liquid crystal compounds, two or more kinds of disk-like liquid crystal compounds, or a rod-like liquid crystal compound and a disk-like liquid crystal compound may be used as the liquid crystal compound.

Since changes in temperature and humidity in optical properties can be made small, it is more preferable to form the negative A-plate using a liquid crystal compound (rod-like liquid crystal compound or disk-like liquid crystal compound) having a polymerizable group. The liquid crystal compound may be a mixed compound of two or more kinds. In this case, it is preferable that at least one has two or more polymerizable groups.

That is, it is preferable that the negative A-plate is a layer formed by fixing a liquid crystal compound (rod-like liquid crystal compound or disk-like liquid crystal compound) having a polymerizable group through polymerization or the like. In this case, after the layer is formed, the liquid crystal compound does not need to exhibit liquid crystallinity any longer.

The kind of the polymerizable group is not particularly limited and a polymerizable group capable of causing radical polymerization or cationic polymerization is preferable.

A known radically polymerizable group can be used as a radically polymerizable group, and an acryloyl group or a methacryloyl group is preferable.

As a cationically polymerizable group, a known cationically polymerizable group can be used, and specific examples thereof include an alicyclic ether group, a cyclic acetal group, a cyclic lactone group, a cyclic thioether group, a spiro ortho ester group, and a vinyloxy group. Among these, an alicyclic ether group or a vinyloxy group is preferable, and an epoxy group, an oxetanyl group, or a vinyloxy group is more preferable.

Examples of particularly preferable polymerizable groups include the following.

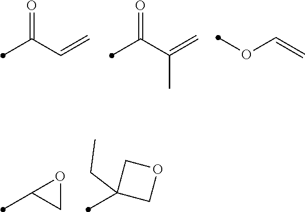

The method of forming the negative A-plate is not particularly limited and known methods may be used.

Among these, from the viewpoint of easily control of the in-plane retardation, a method of applying a negative A-plate forming composition including a liquid crystal compound having a polymerizable group (hereinafter, simply referred to as a “polymerizable liquid crystal compound”) (hereinafter, simply referred to as a “composition”) to form a coating film, subjecting the coating film to an alignment treatment to align the polymerizable liquid crystal compound, and subjecting the obtained coating film to a curing treatment (ultraviolet irradiation (photoirradiation treatment) or heating treatment) to form a negative A-plate is preferable.

Hereinafter, the procedures of the method will be described in detail.

First, a composition is applied to a support to form a coating film, and the coating film is subjected to an alignment treatment to align a polymerizable liquid crystal compound.

The composition used includes a polymerizable liquid crystal compound. The definition of the polymerizable liquid crystal compound is as described above.

The content of the polymerizable liquid crystal compound in the composition is not particularly limited and from the viewpoint of easily control of the in-plane retardation, the content of the polymerizable liquid crystal compound is preferably 50% by mass or more, more preferably 70% by mass or more, and even more preferably 90% by mass or more with respect to the total solid content of the composition. The upper limit is not particularly limited and is 99% by mass or less in many cases.

The total solid content in the composition does not include a solvent.

The composition may include components other than the above-described polymerizable liquid crystal compound.

For example, the composition may include a polymerization initiator. A polymerization initiator to be used is selected according to the kind of polymerization reaction and examples thereof include a thermal polymerization initiator and a photopolymerization initiator. Examples of the photopolymerization initiator include α-carbonyl compounds, acyloin ethers, α-hydrocarbon-substituted aromatic acyloin compounds, polynuclear quinone compounds, and a combination of triarylimidazole dimer and p-aminophenyl ketone.

The content of the polymerization initiator in the composition is preferably 0.01% to 20% by mass and more preferably 0.5% to 5% by mass with respect to the total solid content of the composition.

In addition, the composition may contain a polymerizable monomer.

The polymerizable monomer may be, for example, a radically polymerizable or cationically polymerizable compound. The polymerizable monomer is preferably a polyfunctional radically polymerizable monomer and is more preferably a polymerizable monomer which is copolymerized with the liquid crystal compound having the above-mentioned polymerizable group. Examples of the polymerizable monomer include those described in paragraphs [0018] to [0020] of JP2002-296423A.

The content of the polymerizable monomer in the composition is preferably 1% to 50% by mass and more preferably 2% to 30% by mass with respect to the total mass of the polymerizable liquid crystal compound.

Further, the composition may include a surfactant.

Examples of the surfactant include conventionally known compounds, and a fluorine-based compound is preferable. Specific examples of the surfactant include the compounds described in paragraphs [0028] to [0056] of JP2001-330725A and the compounds described in paragraphs [0069] to [0126] of JP2003-295212.

Further, the composition may include a solvent. An organic solvent is preferably used as the solvent. Examples of the organic solvent include an amide (for example, N,N-dimethylformamide), a sulfoxide (for example, dimethyl sulfoxide), a heterocyclic compound (for example, pyridine), a hydrocarbon (for example, benzene or hexane), an alkyl halide (for example, chloroform or dichloromethane), an ester (for example, methyl acetate, ethyl acetate, or butyl acetate), a ketone (for example, acetone or methyl ethyl ketone), and an ether (for example, tetrahydrofuran or 1,2-dimethoxyethane). Two or more kinds of organic solvents may be used in combination.

Further, the composition may contain various alignment controlling agents such as a vertical alignment agent and a horizontal alignment agent. These alignment controlling agents are compounds capable of controlling the alignment of the liquid crystal compound horizontally or vertically on the interface side.

Further, the composition may include other additives such as an adhesion improver, a plasticizer, a polymer or the like in addition to the above-mentioned components.

The support used is a member having a function as a base material for applying the composition. The support may be a temporary support which is peeled off after applying and curing the composition.

As the support (temporary support), in addition to a plastic film, a glass substrate or the like may be used. Examples of materials constituting the plastic film include polyesters such as polyethylene terephthalate (PET), polycarbonates, acrylic resins, epoxy resins, polyurethanes, polyamides, polyolefins, cellulose derivatives, silicone, and polyvinyl alcohol (PVA).

The thickness of the support may be about 5 to 1000 μm and is preferably 10 to 250 μm and more preferably 15 to 90 μm.

If necessary, an alignment layer may be arranged on the support.

The alignment layer generally contains a polymer as a main component. Polymers for alignment layers are described in many documents, and many commercial products are available. The polymer to be used is preferably polyvinyl alcohol, polyimide, or a derivative thereof.

The alignment layer is preferably subjected to a known rubbing treatment.

The thickness of the alignment layer is preferably 0.01 to 10 μm and more preferably 0.01 to 1 μm.

Examples of the method for applying the composition include a curtain coating method, a dip coating method, a spin coating method, a printing coating method, a spray coating method, a slot coating method, a roll coating method, a slide coating method, a blade coating method, a gravure coating method, and a wire bar method. In the case of performing application using any of the coating methods, single layer coating is preferable.

The coating film formed on the support is subjected to an alignment treatment to align the polymerizable liquid crystal compound in the coating film.

The alignment treatment can be performed by drying the coating film at room temperature or by heating the coating film. In the case of a thermotropic liquid crystal compound, generally, the liquid crystal phase formed by the alignment treatment can be transferred by changing temperature or pressure. In the case of a liquid crystal compound having lyotropic properties, the liquid crystal phase can be transferred according to the compositional ratio such as the amount of a solvent.

The conditions of the case of heating the coating film are not particularly limited. However, the heating temperature is preferably 50° C. to 150° C. and the heating time is preferably 10 seconds to 5 minutes.

Next, the coating film in which the polymerizable liquid crystal compound is aligned is subjected to a curing treatment.

The method of the curing treatment performed on the coating film in which the polymerizable liquid crystal compound is aligned is not particularly limited, and examples thereof include a photoirradiation treatment and a heating treatment. Among these, from the viewpoint of production suitability, a photoirradiation treatment is preferable and an ultraviolet irradiation treatment is more preferable.

The irradiation conditions for the photoirradiation treatment are not particularly limited and the irradiation amount is preferably 50 to 1000 mJ/cm².

(Positive A-Plate)

The positive A-plate is a layer arranged on the polarizer through the negative A-plate in a circularly polarizing plate described later. The positive A-plate preferably has a single layer structure.

The in-plane retardation of the positive A-plate at a wavelength of 550 nm is 100 to 200 nm, and is preferably 117 to 157 nm and more preferably 127 to 147 nm from the viewpoint that the effect of the present invention is more excellent.

The Rth(550) of the positive A-plate, which is a retardation in the thickness direction at a wavelength of 550 nm, is preferably 50 to 100 nm, more preferably 58 to 78 nm, and even more preferably 63 to 74 nm from the viewpoint that the effect of the present invention is more excellent.

The positive A-plate may exhibit forward wavelength dispersibility (characteristics in which the in-plane retardation decreases as the measurement wavelength increases) or reverse wavelength dispersibility (characteristics in which the in-plane retardation increases as the measurement wavelength increases), but from the viewpoint that the effect of the present invention is more excellent, it is preferable that the positive A-plate exhibits reverse wavelength dispersibility. The forward wavelength dispersibility and the reverse wavelength dispersibility are preferably exhibited in the visible light range.

In order to set the in-plane retardation of the positive A-plate to appropriately exhibit reverse wavelength dispersibility, specifically, the Re(450 nm)/Re(550 nm) of the positive A-plate is preferably 0.70 or more and less than 1.00 and more preferably 0.80 to 0.90, and the Re(650 nm)/Re(550 nm) of the positive A-plate is preferably more than 1.00 and 1.20 or less and more preferably 1.02 to 1.10.

The Re(450) and the Re(650) represent in-plane retardations of the positive A-plate measured at wavelengths of 450 nm and 650 nm, respectively.

The thickness of the positive A-plate is not particularly limited and is adjusted such that the in-plane retardation is in a predetermined range. From the viewpoint of reducing the thickness of the phase difference film, the thickness is preferably 10 μm or less, more preferably 0.5 to 5.0 μm, and even more preferably 1 to 2.5 μm.

In the present specification, the thickness of the positive A-plate means the average thickness of the positive A-plate. The thickness is obtained by measuring the thickness at 5 random points in the positive A-plate and arithmetically averaging those values.

As shown in FIG. 2, an angle θ formed between the in-plane slow axis of the negative A-plate 12 and the in-plane slow axis of the positive A-plate 14 is 45°±10°. That is, the angle θ is 35° to 55°. In this range, from the viewpoint that the effect of the present invention is more excellent, the angle θ is preferably 40° to 50°, more preferably 42° to 48°, and even more preferably greater than 440 and smaller than 46°.

The angle means the angle formed between the in-plane slow axis of the negative A-plate and the in-plane slow axis of the positive A-plate in the case of being viewed in the normal direction of the surface of the negative A-plate.

The material constituting the positive A-plate is not particularly limited as long as the above characteristics are exhibited, and the aspects described in the above-mentioned negative A-plate may be used. Among these, from the viewpoint of easily controlling the above characteristics, the positive A-plate is preferably a layer formed by fixing a liquid crystal compound (rod-like liquid crystal compound or disk-like liquid crystal compound) having a polymerizable group through polymerization or the like. In this case, after the layer is formed, the liquid crystal compound does not need to exhibit liquid crystallinity any longer.

The method of forming the positive A-plate is not particularly limited and known methods can be adopted. For example, the above-mentioned method of forming the negative A-plate may be used.

Among these, as the liquid crystal compound having the polymerizable group used in a case of forming the positive A-plate, a compound represented by Formula (I) is preferable.

L₁-G₁-D₁-Ar-D₂-G₂-L₂ Formula (I)

D₁ and D₂ each independently represent —CO—O—, —O—CO—, —C(═S)O—, —O—C(═S)—, —CR¹R²—, —CR¹R²—CR³R⁴—, —O—CR¹R²—, —CR¹R²—O—, —CR¹R²—O—CR³R⁴—, —CR¹R²—O—CO—, —O—OC—CR¹R²—, —CR¹R²—O—CO—CR³R⁴—, —CR¹R²—CO—O—CR³R⁴—, —NR¹—CR²R³—, —CR¹R²—NR³—, —CO—NR¹—, or —NR¹—CO—, and R¹, R², R³, and R⁴ each independently represent a hydrogen atom, a halogen atom, or an alkyl group having 1 to 4 carbon atoms.

G₁ and G₂ each independently represent a divalent alicyclic hydrocarbon group having 5 to 8 carbon atoms, a methylene group contained in the alicyclic hydrocarbon group may be substituted by —O—, —S—, or —NR⁶—, and R⁶ represents a hydrogen atom or an alkyl group having 1 to 6 carbon atoms.

L₁ and L₂ each independently represent a monovalent organic group, and at least one selected from the group consisting of L₁ and L₂ represents a monovalent group having a polymerizable group.

Ar represents a divalent aromatic ring group represented by Formula (II-1), (II-2), (II-3), or (II-4).

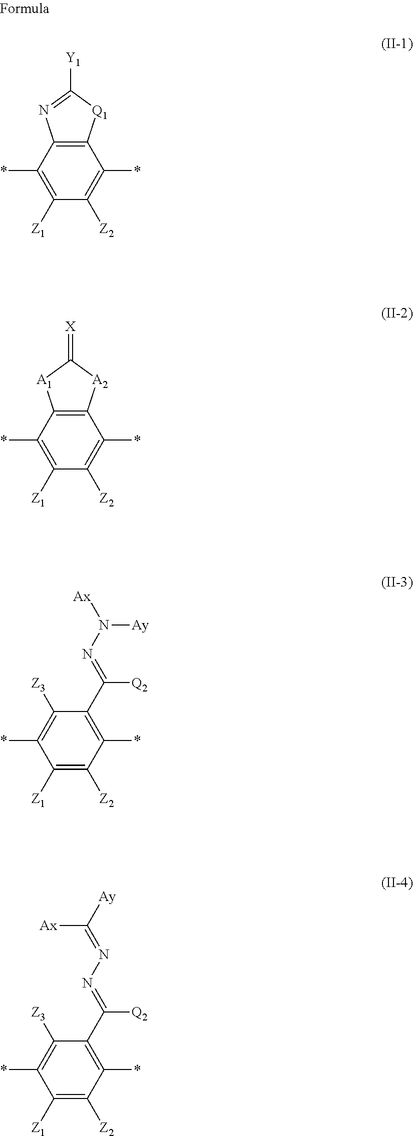

Q₁ represents —S—, —O—, or —NR¹¹—, and R¹¹ represents a hydrogen atom or an alkyl group having 1 to 6 carbon atoms. Y¹ represents an aromatic hydrocarbon group having 6 to 12 carbon atoms or an aromatic heterocyclic group having 3 to 12 carbon atoms. Z₁, Z₂, and Z₃ each independently represent a hydrogen atom, an aliphatic hydrocarbon group having 1 to 20 carbon atoms, an alicyclic hydrocarbon group having 3 to 20 carbon atoms, a monovalent aromatic hydrocarbon group having 6 to 20 carbon atoms, a halogen atom, a cyano group, a nitro group, —NR¹²R¹³, or —SR¹². Z₁ and Z₂ may be bonded to each other to form an aromatic hydrocarbon ring or an aromatic heterocyclic ring, and R¹² and R¹³ each independently represent a hydrogen atom or an alkyl group having 1 to 6 carbon atoms. A₁ and A₂ each independently represent a group selected from the group consisting of —O—, —NR²¹— (R²¹ represents a hydrogen atom or a substituent), —S—, and —CO—. X represents a non-metal atom of Groups XIV to XVI to which a hydrogen atom or a substituent may be bonded. Ax represents an organic group having 2 to 30 carbon atoms and having at least one aromatic ring selected from the group consisting of an aromatic hydrocarbon ring and an aromatic heterocyclic ring. Ay represents a hydrogen atom, an alkyl group having 1 to 6 carbon atoms which may have a substituent, or an organic group having 2 to 30 carbon atoms and having at least one aromatic ring selected from the group consisting of an aromatic hydrocarbon ring and an aromatic heterocyclic ring. The aromatic ring in Ax and Ay may have a substituent, and Ax and Ay may be bonded to each other to form a ring. Q₂ represents a hydrogen atom or an alkyl group having 1 to 6 carbon atoms which may have a substituent.

As for definitions and preferable ranges of the individual substituents of the compound represented by Formula (I), D₁, D₂, G₁, G₂, L₁, L₂, R¹, R², R³, R⁴, Q₁, Y₁, Z₁, and Z₂ of Formula (I) can be referred respectively to the description on D¹, D², G¹, G², L¹, L², R⁴, R⁵, R⁶, R⁷, X¹, Y¹, Q¹, and Q² of Compound (A) in JP2012-021068A, A₁, A₂, and X of Formula (I) can be respectively referred to the description on A₁, A₂, and X of the compound represented by Formula (I) in JP2008-107767A, and Ax, Ay, and Q₂ of Formula (I) can be respectively referred to the description on Ax, Ay, and Q¹ of the compound represented by Formula (I) in WO2013/018526A. Z₃ can be referred to the description on Q¹ of Compound (A) in JP2012-021068A.

One of L₁ and L₂ is preferably a group represented by -D₃-G₃-Sp-P₃. In addition, both L₁ and L₂ may be groups represented by -D₃-G₃-Sp-P₃.

D₃ has the same definition as D₁.

G₃ represents a single bond, a divalent aromatic ring group or heterocyclic group having 6 to 12 carbon atoms, or a divalent alicyclic hydrocarbon group having 5 to 8 carbon atoms, and the methylene group included in the alicyclic hydrocarbon group may be substituted by —O—, —S—, or —NR⁷—, where R⁷ represents a hydrogen atom or an alkyl group having 1 to 6 carbon atoms.

Sp represents a single bond, an alkylene group, —O—, —C(═O)—, —NR⁸—, or a group formed by combining these groups. Examples of the group formed by combining these groups include —(CH₂)ₙ—, —(CH₂)ₙ—O—, —(CH₂—O—)ₙ—, —(CH₂CH₂—O—)ₘ, —O—(CH₂)ₙ—, —O—(CH₂)ₙ—O—, —O—(CH₂—O—)ₙ—, —O—(CH₂CH₂—O—)ₘ, —C(═O)—O—(CH₂)ₙ—, —C(═O)—O—(CH₂)ₙ—O—, —C(═O)—O—(CH₂—O—)ₙ—, —C(═O)—O—(CH₂CH₂—O—)ₘ, —C(═O)—NR⁸—(CH₂)ₙ—, —C(═O)—NR⁸—(CH₂)ₙ—O—, —C(═O)—NR⁸—(CH₂—O—)ₙ—, —C(═O)—NR⁸—(CH₂CH₂—O—)ₘ, and —(CH₂)ₙ—O—C(═O)—(CH₂)ₙ—C(═O)—O—(CH₂)ₙ—O—. Here, n represents an integer of 2 to 12, m represents an integer of 2 to 6, and R⁸ represents a hydrogen atom or an alkyl group having 1 to 6 carbon atoms. In a case where n is 3 or greater, the alkylene group represented by —(CH₂)ₙ— may be branched.

P₃ represents a polymerizable group. The definition of the polymerizable group is as described above.

(Other Layers)

The phase difference film may include layers other than the negative A-plate and the positive A-plate within a range not impairing the effect of the present invention.

For example, the phase difference film may include an alignment layer having a function of defining the alignment direction of the liquid crystal compound. The position where the alignment layer is arranged is not particularly limited and for example, the alignment layer may be arranged between the negative A-plate and the positive A-plate.

The material constituting the alignment layer and the thickness of the alignment layer are as described above.

In addition, the phase difference film may include an adhesive layer or a pressure sensitive adhesive layer for bonding the respective layers.

The method of producing the phase difference film is not particularly limited and for example, a method of laminating the negative A-plate and the positive A-plate respectively prepared through an adhesive or a pressure sensitive adhesive may be used.

The phase difference film can be applied for various applications, and particularly, can be suitably applied to antireflection application. More specifically, the circularly polarizing plate can be suitably applied to a display device such as an organic EL display device for the antireflection application.

<Circularly Polarizing Plate>

A circularly polarizing plate according to an embodiment of the present invention will be described with reference to the drawings. FIG. 3 is a cross-sectional view showing a circularly polarizing plate according to the present invention.

A circularly polarizing plate 16 has a polarizer 18, a negative A-plate 12, and a positive A-plate 14 in this order.

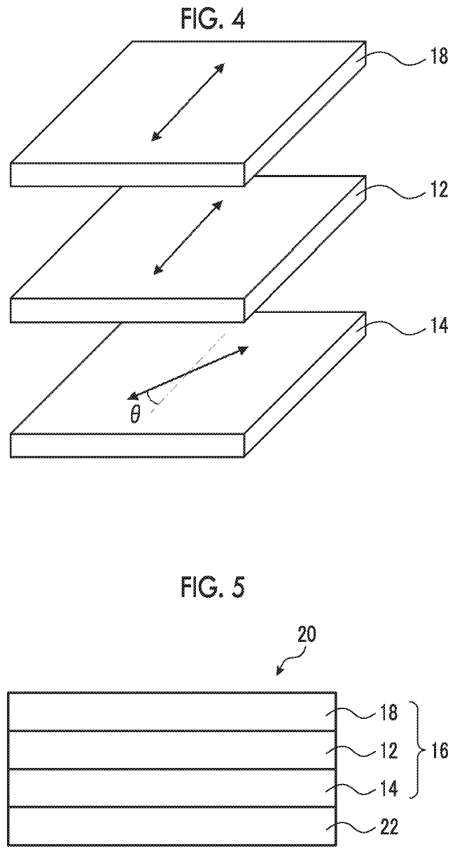

In addition, FIG. 4 shows the relationship between the absorption axis of the polarizer 18, the in-plane slow axis of the negative A-plate 12, and the in-plane slow axis of the positive A-plate 14. In FIG. 4, the arrow in the polarizer 18 represents the direction of the absorption axis, and the arrows in the negative A-plate 12 and the positive A-plate 14 represent the direction of the in-plane slow axis in the respective layers.

Hereinafter, each member included in the circularly polarizing plate 16 will be described in detail.

First, the aspects of the negative A-plate 12 and the positive A-plate 14 included in the circularly polarizing plate 16 are as described above.

(Polarizer)

The polarizer may be a member having a function of converting light into specific linearly polarized light (linear polarizer) and for example, an absorptive type polarizer may be used.

As the absorptive type polarizer, for example, an iodine-based polarizer, a dye-based polarizer using a dichroic dye, a polyene-based polarizer, and the like may be used. The iodine-based polarizer and the dye-based polarizer include a coating type polarizer and a stretching type polarizer, and any one of these polarizers can be applied. Of these polarizers, a polarizer, which is prepared by allowing polyvinyl alcohol to adsorb iodine or a dichroic dye, and performing stretching, is preferable.

In addition, examples of a method of obtaining a polarizer by performing stretching and dyeing in a state of a laminated film in which a polyvinyl alcohol layer is formed on a base material include methods disclosed in JP5048120B, JP5143918B, JP5048120B, JP4691205B, JP4751481B, and JP4751486B, and known technologies related to these polarizers can be preferably used.

Among these, from the point of handleability, the polarizer is preferably a polarizer containing a polyvinyl alcohol-based resin (a polymer including —CH₂—CHOH— as a repeating unit, in particular, at least one selected from the group consisting of polyvinyl alcohol and an ethylene-vinyl alcohol copolymer is preferable).

The thickness of the polarizer is not particularly limited but from the viewpoint of achieving excellent handleability and excellent optical properties, the thickness is preferably 35 μm or less, more preferably 3 to 25 μm, and even more preferably 4 to 15 μm. Within the thickness range, an image display device can be made thin.

As shown in FIG. 4, the absorption axis of the polarizer 18 and the in-plane slow axis of the negative A-plate 12 are parallel to each other. The definition of parallel is as described above, and in other words, the angle formed between the absorption axis of the polarizer 18 and the in-plane slow axis of the negative A-plate 12 is in a range of 0° to 10°. In this range, the angle formed between the absorption axis of the polarizer 18 and the in-plane slow axis of the negative A-plate 12 is preferably 0° or more and less than 5°, more preferably 0° or more and less than 2°, and even more preferably 0° or more and less than 1°.

The angle means an angle formed between the absorption axis of the polarizer 18 and the in-plane slow axis of the negative A-plate 12 in a case of being viewed in the normal direction of the surface of the polarizer 18.

In addition, the angle θ formed between the absorption axis of the polarizer 18 and the in-plane slow axis of the positive A-plate 14 is preferably 45°±10°. That is, the angle θ formed between the absorption axis of the polarizer 18 and the in-plane slow axis of the positive A-plate 14 is preferably 35° to 55°. In this range, from the viewpoint that the effect of the present invention is more excellent, the angle θ formed between the absorption axis of the polarizer 18 and the in-plane slow axis of the positive A-plate 14 is more preferably 40° to 50° and even more preferably 42° to 48°.

The angle θ means an angle formed between the absorption axis of the polarizer 18 and the in-plane slow axis of the positive A-plate 14 in a case of being viewed in the normal direction of the surface of the polarizer 18.

(Other Layers)

The circularly polarizing plate 16 may include layers other than the polarizer 18, the negative A-plate 12, and the positive A-plate 14 within a range not impairing the effect of the present invention.

For example, the circularly polarizing plate 16 may include an alignment layer having a function of defining the alignment direction of the liquid crystal compound. The position where the alignment layer is arranged is not particularly limited, and for example, the alignment layer may be arranged between the negative A-plate 12 and the positive A-plate 14.

The material constituting the alignment layer and the thickness of the alignment layer are as described above.

In addition, the circularly polarizing plate 16 may include an adhesive layer or a pressure sensitive adhesive layer for bonding the respective layers.

Further, a polarizer protective film may be arranged on the surface of the polarizer.

The configuration of the polarizer protective film is not particularly limited, and may be, for example, a transparent support or a hardcoat layer, or a laminate of a transparent support and a hardcoat layer.

A known layer can be used as a hardcoat layer and the hardcoat layer may be, for example, a layer obtained by polymerizing and curing the above-mentioned polyfunctional monomer.

Further, as a transparent support, a known transparent support can be used. For example, as the material for forming the transparent support, a cellulose polymer typified by triacetyl cellulose (hereinafter, referred to as cellulose acylate), a thermoplastic norbornene resin (ZEONEX and ZEONOR manufactured by Zeon Corporation, ARTON manufactured by JSR Corporation, or the like), an acrylic resin, or a polyester resin may be used.

The thickness of the polarizer protective film is not particularly limited and from the viewpoint of being capable of reducing the thickness of the polarizing plate, the thickness is preferably 40 μm or less and more preferably 25 μm or less.

The method of producing the circularly polarizing plate is not particularly limited and for example, a method of laminating the polarizer, the negative A-plate, and the positive A-plate respectively prepared through an adhesive or a pressure sensitive adhesive may be used.

The circularly polarizing plate can be applied for various applications, and particularly, can be suitably applied to antireflection application. More specifically, the circularly polarizing plate can be suitably applied to a display device such as an organic EL display device for the antireflection application.

<Organic EL Display Device>

An organic EL display device according to an embodiment of the present invention will be described with reference to the drawing. FIG. 5 is a cross-sectional view showing an organic EL display device according to the present invention.

An organic EL display device 20 has a polarizer 18, a negative A-plate 12, a positive A-plate 14, and an organic EL display panel 22 in this order. As shown in FIG. 5, the polarizer 18 in the circularly polarizing plate 16 is arranged on the viewing side.

The organic EL display panel 22 is a display panel constituted using an organic EL element in which an organic light emitting layer (organic electroluminescent layer) is held between electrodes (between a cathode and an anode).

The configuration of the organic EL display panel 22 is not particularly limited and a known configuration is adopted.

### EXAMPLES

The features of the present invention will be described in more detail with reference to the following Examples. The materials, the amount of the materials used, the ratio between the materials, the content and the procedures of treatment, and the like shown in the following examples can be appropriately modified as long as the modification does not depart from the gist of the present invention. Accordingly, the scope of the present invention is not limited to the following specific examples.

### Example 1

<<Preparation of Polarizer>>

<Preparation of Protective Film>

The following composition was put into a mixing tank and was stirred to dissolve the respective components, thereby preparing a core layer cellulose acylate dope.

| | |
|---|---|
| Cellulose acetate having an acetyl substitution degree | 100 parts by mass |
| of 2.88 | |
| Ester oligomer (Compound 1-1) | 10 parts by mass |
| Durability improver (Compound 1-2) | 4 parts by mass |
| Ultraviolet absorbing agent (Compound 1-3) | 3 parts by mass |
| Methylene chloride (first solvent) | 438 parts by mass |
| Methanol (second solvent) | 65 parts by mass |

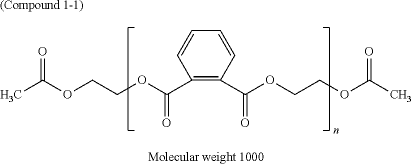

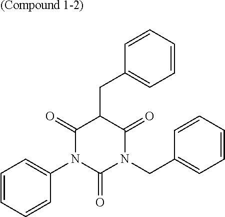 [SMILES: "(Compound 1-2)" ; O=C1C(Cc2ccccc2)C(=O)N(c2ccccc2)C(=O)N1Cc1ccccc1]

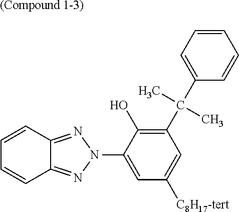

[Preparation of Outer Layer Cellulose Acylate Dope]

10 parts by mass of a matting agent dispersion liquid having the following composition was added to 90 parts by mass of the above-mentioned core layer cellulose acylate dope to prepare an outer layer cellulose acylate dope.

| | |
|---|---|
| Silica particles having an average particle size of | 2 parts by mass |
| 20 nm (AEROSIL R972, manufactured by Nippon | |
| Aerosil Co., Ltd.) | |
| Methylene chloride (first solvent) | 76 parts by mass |
| Methanol (second solvent) | 11 parts by mass |
| Core layer cellulose acylate dope 1 | 1 part by mass |

[Preparation of Cellulose Acylate Film]

Three layers of the core layer cellulose acylate dope and the outer layer cellulose acylate dope on both sides thereof were cast simultaneously onto a drum at 20° C. from a casting port. The film was peeled from the drum in a state where the solvent content of the film was approximately 20% by mass, and both ends in the width direction of the peeled film were fixed with tenter clips. Then, the film was dried while stretching the film 1.2 times in the transverse direction in a state where the residual solvent was 3% to 15% by mass. Thereafter, the stretched film was conveyed between the rolls of a heat treatment apparatus to prepare a cellulose acylate film having a thickness of 25 μm. The film was used as a polarizing plate protective film.

<Preparation of Hardcoat Layer>

As a hardcoat layer forming coating liquid, a curable composition for hardcoat in Table 1 below was prepared.

TABLE 1

| | | | | | UV Initiator | | |
|---|---|---|---|---|---|---|---|
| | Monomer | | | | | Amount | |
| | | | | Total amount | | added | |
| | | | Monomer 1/ | added | | [parts by | |
| | Monomer 1 | Monomer 2 | Monomer 2 | [parts by mass] | Kind | mass] | Solvent |
| Hardcoat 1 | Pentaerythritol | Pentaerythritol | 3/2 | 53.5 | UV initiator 1 | 1.5 | Ethyl |
| | triacrylate | tetraacryalte | | | | | acetate |

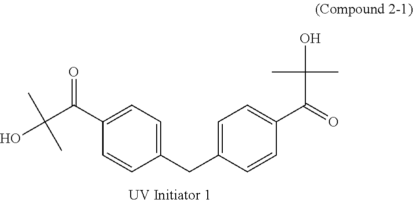 [SMILES: CC(C)(O)C(=O)c1ccc(Cc2ccc(C(=O)C(C)(C)O)cc2)cc1]

The curable composition for hardcoat was applied onto the polarizing plate protective film prepared above. Thereafter, the coating film of the polarizing plate protective film was dried at 100° C. for 60 seconds, and the coating film was cured by irradiating the coating film with ultraviolet (UV) light at 1.5 kW and at 300 mJ under the conditions of nitrogen of 0.1% or less, thereby preparing a protective film with a hardcoat layer which has a hardcoat layer with a thickness of 3 μm. The film thickness of the hardcoat layer was adjusted by adjusting the coating amount in a die coating method using a slot die.

<Preparation of Polarizer with Protective Film>

1) Saponification of Film

The protective film with a hardcoat layer thus prepared was immersed in a 4.5 mol/L sodium hydroxide aqueous solution (saponification solution) whose temperature was adjusted to 37° C. for 1 minute. Thereafter, the protective film with a hardcoat layer was taken out and was washed with water. Then, the protective film with a hardcoat layer was immersed in a 0.05 mol/L sulfuric acid aqueous solution for 30 seconds, and then the protective film with a hardcoat layer was taken out and further caused to pass through a water washing bath. Then, the obtained film was dewatered repeatedly three times with an air knife to remove water, and then dried by retaining in a drying zone at 70° C. for 15 seconds, thereby preparing a saponified protective film with a hardcoat layer.

2) Preparation of Polarizer

The film was stretched in the longitudinal direction with two pairs of nip rolls having a difference in circumferential speed according to Example 1 of JP2001-141926A under changed drying conditions, thereby preparing a polarizer having a width of 1330 mm and a thickness of 15 μm.

3) Lamination

The prepared polarizer and the saponified protective film with a hardcoat layer were laminated by a roll-to-roll process using a 3 mass % aqueous solution of PVA (PVA-117H, manufactured by Kuraray Co., Ltd.) as an adhesive in such a manner that the absorption axis of the polarizer and the longitudinal direction of the film were arranged to be parallel to each other (protective film with a hardcoat layer), and thus a polarizer with a protective film was prepared.

At this time, the polarizer and the protective film with a hardcoat layer subjected to the saponification treatment were laminated such that the cellulose acylate film faced the polarizer.

<<Preparation of Negative A-Plate>>

<Preparation of Temporary Support>

A pellet of a mixture (Tg 127° C.) of 90 parts by mass of an acrylic resin having a lactone ring structure represented by Formula (II) {copolymerization monomer mass ratio=methyl methacrylate/methyl 2-(hydroxymethyl) acrylate=8/2, lactone cyclization ratio: about 100%, content ratio of the lactone ring structure: 19.4%, weight-average molecular weight: 133,000, melt flow rate: 6.5 g/10 min (240° C., 10 kgf), Tg 131° C.}, and 10 parts by mass of acrylonitrile-styrene (AS) resin {Toyo AS AS20, manufactured by Toyo-Styrene Co., Ltd.}; was supplied to a twin-screw extruder and melt-extruded in a sheet form at about 280° C. Thereafter, the melt-extruded sheet was longitudinally stretched in a longitudinal uniaxial stretching machine at an aeration temperature of 130° C., a sheet surface temperature of 120° C., a stretching rate of 30%/min, and a stretching ratio of 35%. Then, the longitudinally stretched sheet was transversely stretched at using a tenter type stretching machine, at an aeration temperature of 130° C., a sheet surface temperature of 120° C., a stretching rate of 30%/min, and a stretching ratio of 35%. Then, both ends of the transversely stretched sheet were cut off before the winding section and the sheet was wound up as a roll film having a length of 4000 m. Thus, a long temporary support having a thickness of 40 μm was prepared.

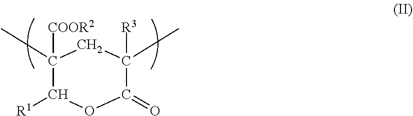

In Formula (II), R¹ represents a hydrogen atom and R² and R³ represent a methyl group.

<Formation of Alignment Layer>

An alignment layer forming coating liquid having the following composition was continuously applied to the temporary support using a #14 wire bar. The temporary support coated with the alignment layer forming coating liquid was dried with warm air at 60° C. for 60 seconds and further dried with warm air at 100° C. for 120 seconds, thereby forming an alignment layer on the temporary support. Further, a rubbing treatment was performed on the coating film in the longitudinal direction of the temporary support, and thus an alignment layer was formed.

The saponification degree of modified polyvinyl alcohol used was 96.8%.

Composition of Alignment Layer Forming Coating Liquid (A)

| | |
|---|---|
| Modified polyvinyl alcohol below | 10 parts by mass |
| Water | 308 parts by mass |
| Methanol | 70 parts by mass |
| isopropanol | 29 parts by mass |
| Photopolymerization initiator (IRGACURE | 0.8 parts by mass |
| (registered trademark) 2959, manufactured | |
| by BASF SE) | |

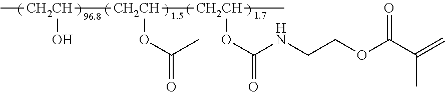

Modified Polyvinyl Alcohol

The compositional ratio of modified polyvinyl alcohol is described by a mole fraction.

<Formation of Negative A-Plate>

Next, a composition 1 shown in Table 2 described later was prepared by dissolving the composition in methyl ethyl ketone (MEK) such that the concentration of solid contents was 10% by mass. Thus, a coating liquid was obtained. The obtained coating liquid was applied to the alignment layer using a bar coater and heated and aged at 120° C. for 2 minutes. Thus, a homogeneous alignment state of the liquid crystal compound in the coating film was obtained. Then, the coating film was kept at 120° C. and was irradiated with ultraviolet rays at 100 mJ/cm² using a metal halide lamp at 120° C. to form a negative A-plate (film thickness: 1.0 μm). By the above-described procedure, a film A having a temporary support, an alignment layer, and a negative A-plate was obtained.

The numerical values in Table 2 represent parts by mass.

TABLE 2

| | Composition | Composition |
|---|---|---|
| | 1 | 2 |
| Rod-like liquid crystal | | 44 |
| compound (1) | | |
| Rod-like liquid crystal | | 44 |
| ompound (2) | | |
| Disk-like liquid crystal | 80 | |
| compound 101 | | |
| Disk-like liquid crystal | 20 | |
| compound 102 | | |
| Polymerization initiator 1 | 1.5 | 1.5 |
| Polymerization initiator 2 | 1.5 | 1.5 |
| Vertical alignment agent 1 | 0.1 | |
| Vertical alignment agent 2 | 0.9 | |
| Polymerizable compound 1 | 0.5 | |
| Polymerizable compound 2 | | 12 |
| HISOLVE MTEM | | 2 |
| NK ESTER A-200 | | 1 |
| Surfactant 1 | 0.2 | |
| Surfactant 2 | 0.4 | |
| Surfactant 3 | | 0.2 |

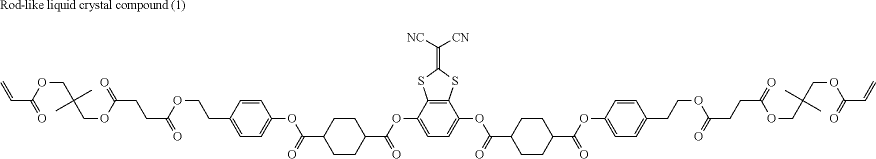 [SMILES: "Rod-like liquid crystal compound (1)" ; C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

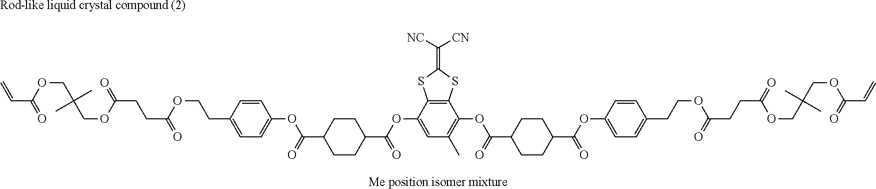 [SMILES: "Rod-like liquid crystal compound (2)" ; C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1 ; "Me position isomer mixture"]

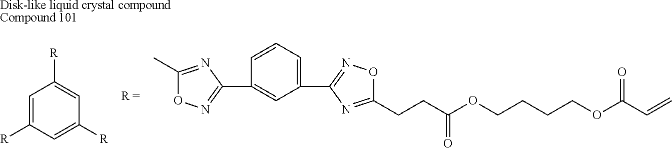

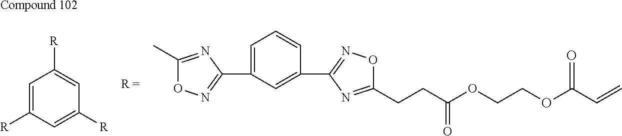

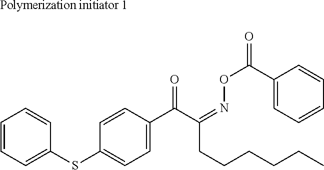 [SMILES: "Polymerization initiator 1" ; CCCCCC/C(=N/OC(=O)c1ccccc1)C(=O)c1ccc(Sc2ccccc2)cc1]

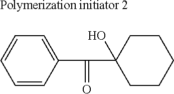

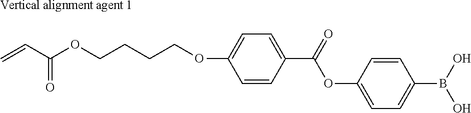 [SMILES: "Vertical alignment agent 1" ; C=CC(=O)OCCCCOc1ccc(C(=O)Oc2ccc(B(O)O)cc2)cc1]

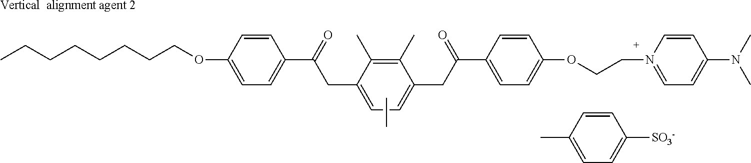

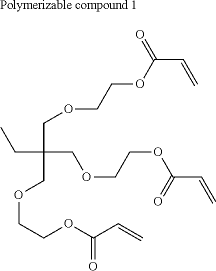

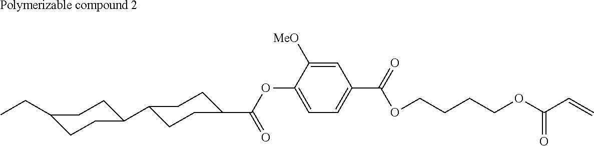 [SMILES: "Polymerizable compound 2" ; C=CC(=O)OCCCCOC(=O)c1ccc(OC(=O)C2CCC(C3CCC(CC)CC3)CC2)c(OC)c1]

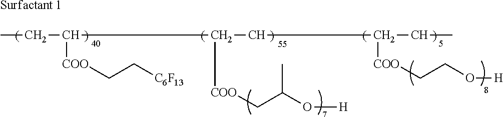

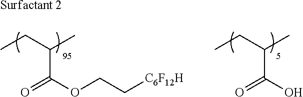

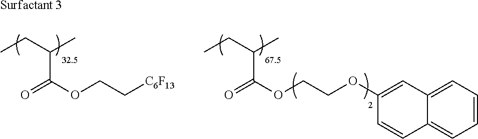

<<Preparation of Positive A-Plate>>

A temporary support with an alignment layer was produced according to the method described in the <<Preparation of Negative A-Plate>>.

<Formation of Positive A-Plate>

Next, the composition 2 shown in Table 2 described above was prepared by dissolving the composition in MEK such that the solid content concentration was 10% by mass. Thus, a coating liquid was obtained. The obtained coating liquid was applied to the alignment layer using a bar coater and heated and aged at 120° C. for 2 minutes. Thus, a homogeneous alignment state of the liquid crystal compound in the coating film was obtained. Then, the coating film was kept at 120° C. and was irradiated with ultraviolet rays at 100 mJ/cm² using a metal halide lamp at 120° C. to form a positive A-plate (film thickness: 2.2 μm). By the above-described procedure, a film B having a temporary support, an alignment layer, and a positive A-plate was obtained.

<<Preparation of Circularly Polarizing Plate>>

The polarizer with a protective film and the film A were laminated on the polarizer side surface of the obtained polarizer with a protective film through a commercially available acrylic adhesive (UV-3300 manufactured by Toagosei Co., Ltd.) such that the polarizer faced the negative A-plate, and thus a laminate was obtained. The laminate was irradiated with ultraviolet rays at an irradiation amount of 100 mJ/cm² from the temporary support side using a metal halide lamp to cure the adhesive. Then, the temporary support was peeled off from the obtained film.

Next, on the negative A-plate side surface of the film including the polarizer with a protective film and the negative A-plate, the film and the film B were laminated through a commercially available acrylic adhesive (UV-3300 manufactured by Toagosei Co., Ltd.) such that the negative A-plate faced the positive A-plate, and thus a laminate was obtained. The laminate was irradiated with ultraviolet rays at an irradiation amount of 100 mJ/cm² from the temporary support side using a metal halide lamp to cure the adhesive. Then, the temporary support was peeled off from the obtained film, and thus a circularly polarizing plate having a polarizer, a negative A-plate, and a positive A-plate in this order was prepared.

Each layer was laminated so as to have angles shown in “Angle (°) formed between in-plane slow axis of negative A-plate and absorption axis of polarizer” and “Angle (°) formed between in-plane slow axis of positive A-plate and absorption axis of polarizer” shown in Table 3 described later.

### Examples 2 to 7 and Comparative Examples 1 to 3

Circularly polarizing plates were prepared according to the same procedure as in Example 1 except that the thickness and the angle (°) formed between the in-plane slow axis of the negative A-plate and the absorption axis of the polarizer in the <<Preparation of Negative A-Plate>> and <<Preparation of Positive A-Plate>> were changed as shown in Table 3 described later.

The temporary support was peeled off from each of the films A and B and the Re(550), Rth(550), Re(450)/Re(550), and Re(650)/Re(550) of the negative A-plate and the positive A-plate were measured using AxoScan.

[Mounting of Circularly Polarizing Plate on Organic EL Display Panel and Evaluation of Display Performance]

(Mounting of Circularly Polarizing Plate on Organic EL Display Device)

GALAXY S IV manufactured by SAMSUNG Co., Ltd. equipped with an organic EL display panel was decomposed, the circularly polarizing plate was peeled off, and each of the circularly polarizing plates of Examples 1 to 7 and Comparative Examples 1 to 3 was laminated on the organic EL display panel to prepare an organic EL display device.

(Evaluation of Display Performance)

The visibility and display quality of the prepared organic EL display device were evaluated under light conditions. In a black display where external light reflected light is most easily visible, the reflected light when fluorescent light was projected from a polar angle of 45 degrees was observed. Specifically, the display quality in the viewing angle direction (polar angle 45 degrees) was evaluated. The results are collectively shown in Table 3.

(Reflectivity)

A: The reflected light is hardly visible.

B: The reflected light is very slightly visible.

C: The reflected light is slightly visible.

D: The reflected light is visible.

TABLE 3

| | | Example 1 | Example 2 | Example 3 | Example 4 | Example 5 |
|---|---|---|---|---|---|---|
| Negative A-plate | Re(550) (nm) | 70 | 60 | 78 | 85 | 70 |
| | Rth(550) (nm) | −35 | −30 | −39 | −43 | −35 |
| | Re(450)/Re(550) | 1.05 | 1.05 | 1.05 | 1.05 | 1.05 |
| | Re(650)/Re(550) | 0.97 | 0.97 | 0.97 | 0.97 | 0.97 |
| | Angle (°) formed between in-plane | 0 | 0 | 0 | 0 | 1 |
| | slow axis of negative A-plate and | | | | | |
| | absorption axis of polarizer | | | | | |
| | Kind of liquid crystal compound | Composition 1 | Composition 1 | Composition 1 | Composition 1 | Composition 1 |
| | Thickness | 1.0 μm | 0.9 μm | 1.1 μm | 1.2 μm | 1.0 μm |
| Positive A-plate | Re(550) (nm) | 138 | 138 | 138 | 138 | 138 |
| | Rth(550) (nm) | 69 | 69 | 69 | 69 | 69 |
| | Re(450)/Re(550) | 0.86 | 0.86 | 0.86 | 0.86 | 0.86 |
| | Re(650)/Re(550) | 1.03 | 1.03 | 1.03 | 1.03 | 1.03 |
| | Angle (°) formed between in-plane | 45 | 45 | 45 | 45 | 44 |
| | slow axis of negative A-plate and | | | | | |
| | in-plane slow axis of positive A- | | | | | |
| | plate | | | | | |
| | Angle (°) formed between in-plane | 45 | 45 | 45 | 45 | 45 |
| | slow axis of positive A-plate and | | | | | |
| | absorption axis of polarizer | | | | | |
| | Kind of liquid crystal compound | Composition 2 | Composition 2 | Composition 2 | Composition 2 | Composition 2 |
| | Thickness | 2.2 μm | 2.2 μm | 2.2 μm | 2.2 μm | 2.2 μm |
| Oblique display | Reflectivity | A | B | B | C | B |
| performance | | | | | | |
| (polar angle 45°) | | | | | | |
| | | | | Comparative | Comparative | Comparative |
| | | Example 6 | Example 7 | Example 1 | Example 2 | Example 3 |
| Negative A-plate | Re(550) (nm) | 70 | 85 | — | 120 | 40 |
| | Rth(550) (nm) | −35 | −43 | — | −60 | −20 |
| | Re(450)/Re(550) | 1.05 | 1.05 | — | 1.05 | 1.05 |
| | Re(650)/Re(550) | 0.97 | 0.97 | — | 0.97 | 0.97 |
| | Angle (°) formed between in-plane | 2 | 2 | — | 0 | 0 |
| | slow axis of negative A-plate and | | | | | |
| | absorption axis of polarizer | | | | | |
| | Kind of liquid crystal compound | Composition 1 | Composition 1 | — | Composition 1 | Composition 1 |
| | Thickness | 1.0 μm | 1.2 μm | — | 1.7 μm | 0.6 μm |
| Positive A-plate | Re(550) (nm) | 138 | 138 | 138 | 138 | 138 |
| | Rth(550) (nm) | 69 | 69 | 69 | 69 | 69 |
| | Re(450)/Re(550) | 0.86 | 0.86 | 0.86 | 0.86 | 0.86 |
| | Re(650)/Re(550) | 1.03 | 1.03 | 1.03 | 1.03 | 1.03 |
| | Angle (°) formed between in-plane | 43 | 43 | — | 45 | 45 |
| | slow axis of negative A-plate and | | | | | |
| | in-plane slow axis of positive A- | | | | | |
| | plate | | | | | |
| | Angle (°) formed between in-plane | 45 | 45 | 45 | 45 | 45 |
| | slow axis of positive A-plate and | | | | | |
| | absorption axis of polarizer | | | | | |
| | Kind of liquid crystal compound | Composition 2 | Composition 2 | Composition 2 | Composition 2 | Composition 2 |
| | Thickness | 2.2 μm | 2.2 μm | 2.2 μm | 2.2 μm | 2.2 μm |
| Oblique display | Reflectivity | B | C | D | D | D |
| performance | | | | | | |
| (polar angle 45°) | | | | | | |

From the relationship between the absorption axis of the polarizer and the in-plane slow axes of the negative A-plate and the positive A-plate, it was confirmed that the phase difference film in the circularly polarizing plate in each example functioned as a film of retardation comparable to that of positive A-plate.

As shown in Table 3, in the organic EL display device according to the present invention, the desired effect was obtained.

Particularly, from the comparison of Examples 1 to 4, it was confirmed that the effect was more excellent in a case where the Re (550) of the negative A-plate was more than 50 nm and less than 80 nm (preferably, in the case of 65 to 75 nm).

On the other hand, in Comparative Example 1 in which the negative A-plate was not provided, and Comparative Examples 2 and 3 in which the Re (550) of the negative A-plate was out of the predetermined range, the desired effect was not obtained. Comparative Example 3 corresponds to the embodiment of WO2016/158298A.

### EXPLANATION OF REFERENCES

10: phase difference film
12: negative A-plate
14: positive A-plate
16: circularly polarizing plate
18: polarizer
20: organic EL display device
22: organic EL display panel

What is claimed is:

1. An organic electroluminescent display device comprising:
an organic electroluminescent display panel; and
a circularly polarizing plate arranged on the organic electroluminescent display panel,
wherein the circularly polarizing plate has a polarizer, and a phase difference film,
the phase difference film has, from a polarizer side, a negative A-plate, and a positive A-plate,
an in-plane retardation of the negative A-plate at a wavelength of 550 nm is more than 50 nm and 90 nm or less,
an in-plane retardation of the positive A-plate at a wavelength of 550 nm is 100 to 200 nm,
an angle formed between an in-plane slow axis of the negative A-plate and an in-plane slow axis of the positive A-plate is 45°±10°, and
the in-plane slow axis of the negative A-plate and an absorption axis of the polarizer are parallel to each other.

2. The organic electroluminescent display device according to claim 1,
wherein the in-plane retardation of the negative A-plate at a wavelength of 550 nm is more than 50 nm and less than 80 nm.

3. The organic electroluminescent display device according to claim 1,
wherein the positive A-plate exhibits reverse wavelength dispersibility.

4. The organic electroluminescent display device according to claim 1,
wherein the in-plane retardation of the positive A-plate at a wavelength of 550 nm is 117 to 157 nm.

5. The organic electroluminescent display device according to claim 1,
wherein the negative A-plate and the positive A-plate have a thickness of 10 m or less, respectively.

6. The organic electroluminescent display device according to claim 1,
wherein both the negative A-plate and the positive A-plate are layers formed by using a liquid crystal compound.

7. A phase difference film comprising:
a negative A-plate; and
a positive A-plate,
wherein an in-plane retardation of the negative A-plate at a wavelength of 550 nm is more than 50 nm and 90 nm or less,
an in-plane retardation of the positive A-plate at a wavelength of 550 nm is 100 to 200 nm, and
an angle formed between an in-plane slow axis of the negative A-plate and an in-plane slow axis of the positive A-plate is 45°±10°.

8. The phase difference film according to claim 7,
wherein the in-plane retardation of the negative A-plate at a wavelength of 550 nm is more than 50 nm and less than 80 nm.

9. The phase difference film according to claim 7,
wherein the positive A-plate exhibits reverse wavelength dispersibility.

10. The phase difference film according to claim 7,
wherein the in-plane retardation of the positive A-plate at a wavelength of 550 nm is 117 to 157 nm.

11. The phase difference film according to claim 7,
wherein the negative A-plate and the positive A-plate have a thickness of 10 μm or less, respectively.

12. The phase difference film according to claim 7,
wherein both the negative A-plate and the positive A-plate are layers formed by using a liquid crystal compound.

13. A circularly polarizing plate comprising:
a polarizer; and
the phase difference film according to claim 7 arranged on the polarizer,
wherein, from a polarizer side, the negative A-plate and the positive A-plate are arranged in this order, and
an in-plane slow axis of the negative A-plate and an absorption axis of the polarizer are parallel to each other.

14. The organic electroluminescent display device according to claim 2,
wherein the positive A-plate exhibits reverse wavelength dispersibility.

15. The organic electroluminescent display device according to claim 2,
wherein the in-plane retardation of the positive A-plate at a wavelength of 550 nm is 117 to 157 nm.

16. The organic electroluminescent display device according to claim 3,
wherein the in-plane retardation of the positive A-plate at a wavelength of 550 nm is 117 to 157 nm.

17. The organic electroluminescent display device according to claim 2,
wherein the negative A-plate and the positive A-plate have a thickness of 10 μm or less, respectively.

18. The organic electroluminescent display device according to claim 3,
wherein the negative A-plate and the positive A-plate have a thickness of 10 μm or less, respectively.

19. The organic electroluminescent display device according to claim 4,
wherein the negative A-plate and the positive A-plate have a thickness of 10 μm or less, respectively.

20. The organic electroluminescent display device according to claim 2,
wherein both the negative A-plate and the positive A-plate are layers formed by using a liquid crystal compound.
